(19) United States
(12) Patent Application Publication
(10) Pub. No.: US 2026/0289358 A1
(43) Pub. Date: Sep. 24, 2026

(54) COMPUTER-IMPLEMENTED SYSTEM AND METHOD FOR ADAPTIVE BEHAVIORAL MODELING AND CONTENT OPTIMIZATION USING ARTIFICIAL INTELLIGENCE TECHNIQUE

(71) Applicant: AskIt-AI, Inc., Dover, DE (US)

(72) Inventors: Lotan MAGAL, Pasadena, CA (US); Neal TSUR, Shoham (IL)

(73) Assignee: AskIt-AI, Inc., Dover, DE (US)

(21) Appl. No.: 19/387,736

(22) Filed: Nov. 13, 2025

Related U.S. Application Data
(60) Provisional application No. 63/774,250, filed on Mar. 19, 2025.

(51) Int. Cl. G06N 5/048; G06F 16/22; G06F 16/25

(52) U.S. Cl. CPC G06N 5/048; G06F 16/2264; G06F 16/258

(57) ABSTRACT

A method and system for simulating responses from virtual personas, the method comprising: using a computer processor, generating a plurality of target audience descriptions; converting the plurality of target audience descriptions into numerical embeddings; converting a pre-existing personality survey into numerical embeddings; determining, with a machine learning model, compatibility of the plurality of target audience descriptions with respondents of the pre-existing personality survey; forming an array of likelihood scores based on the compatibility, wherein columns of the array correspond to the target audience descriptions and rows correspond to the pre-existing personality survey; selecting a subset of the rows of the array with likelihood scores above a user-selected threshold; generating, from the subset, a set of virtual personas combining the plurality of target audience descriptions and the pre-existing personality survey respondents; and simulating responses using the set of virtual personas.

### CROSS REFERENCE TO RELATED APPLICATIONS

This application claims the benefit of U.S. Provisional Patent Application No. 63/774,250, filed Mar. 19, 2025, which is incorporated herein by reference in its entirety.

### FIELD OF THE INVENTION

The present invention relates generally to the field of data processing and more specifically to behavioral modeling using artificial intelligence.

### BACKGROUND OF THE INVENTION

Traditional behavioral research and content optimization methods are often time-consuming, resource-intensive, and limited in scalability. These approaches typically rely on manual data collection and human-driven analysis, which can lead to processing delays, reduced consistency, and decreased accuracy of insights. In addition, behavioral studies may introduce bias due to factors such as question framing, survey structure, or human interaction during data gathering. With advancements in artificial intelligence and machine learning, there is a growing opportunity to improve these processes through computer-implemented techniques that automate data analysis, adaptively model behavioral patterns, and dynamically optimize digital content generation. Such technological improvements enable faster, more consistent, and more accurate processing of behavioral data within computing systems.

### SUMMARY OF THE INVENTION

According to one or more embodiments of the invention, there is provided a method of simulating responses from virtual personas, the method comprising: using a computer processor, generating a plurality of target audience descriptions; converting the plurality of target audience descriptions into numerical embeddings; converting a pre-existing personality survey into numerical embeddings; determining, with a machine learning model, compatibility of the plurality of target audience descriptions with respondents of the pre-existing personality survey; forming an array of likelihood scores based on the compatibility, wherein columns of the array correspond to the target audience descriptions and rows correspond to the pre-existing personality survey; selecting a subset of the rows of the array with likelihood scores above a user-selected threshold; generating, from the subset, a set of virtual personas combining the plurality of target audience descriptions and the pre-existing personality survey respondents; and simulating responses using the set of virtual personas.

According to some embodiments, the target audience descriptions comprise at least one of the following attributes: age range, location, education level, job, and demographic.

According to some embodiments, the simulated responses are responses to questions in a chosen survey and the target audience comprises respondents to the chosen survey.

According to some embodiments, the simulated responses are behavioral responses based on decision-making processes.

According to some embodiments, the simulated responses are responses or reactions to the text message and the target audience comprises recipients of the text message, and the method further comprises receiving, from a human user, an initial text message and iterating the following process: analyzing the simulated responses, wherein the analysis comprises sentiment analysis or click-through rate; and generating, using a large language model, a new text message based on the simulated responses.

According to some embodiments, the method further comprises retaining the simulated responses in a computer memory and using the retained simulated responses to improve subsequent simulated responses.

According to some embodiments, the method further comprises aggregating the responses to simulate a collective response of a group of personas.

According to some embodiments, the accuracy of the collective response is prioritized compared to the accuracy of individual responses of individual personas.

According to some embodiments, the method further comprises embedding one or more additional pre-existing surveys; forming a multidimensional array of persona-question pairs based on the pre-existing personality survey and the one or more additional pre-existing surveys; and forming, using the multidimensional array, a calibration manifold by cross-validating the pre-existing personality survey and the one or more additional pre-existing surveys.

According to some embodiments, the method further comprises adjusting for biases across target audiences using the calibration manifold; validating a question and a target audience with respect to the calibration manifold; and recommending additional data collection or adjustments in the event that the question and/or target audience falls outside of the calibration manifold.

According to some embodiments, the method further comprises retaining, in a computer memory, contextual data from at least one of the pre-existing surveys, the contextual data comprising at least one of: textual content of the questions and responses; type of questions; or format of responses; and using the contextual data to calibrate the simulated responses.

According to one or more embodiments of the invention, there is provided a system for simulating responses from virtual personas, the system comprising: a computer memory and a computer processor, wherein the computer memory holds instructions which, when executed by the computer processor, cause the computer processor to: generate a plurality of target audience descriptions; convert the plurality of target audience descriptions into numerical embeddings; convert a pre-existing personality survey into numerical embeddings; determine, with a machine learning model, compatibility of the plurality of target audience descriptions with respondents of the pre-existing personality survey; form an array of likelihood scores based on the compatibility, wherein columns of the array correspond to the target audience descriptions and rows correspond to the pre-existing personality survey; select a subset of the rows of the array with likelihood scores above a threshold; generate, from the subset, a set of virtual personas combining the plurality of target audience descriptions and the pre-existing personality survey respondents; and simulate responses using the set of virtual personas.

According to some embodiments, the target audience descriptions comprise at least one of the following attributes: age range, location, education level, job, and demographic.

According to some embodiments, the simulated responses are at least one of: responses to questions in a chosen survey and the target audience comprises respondents to the chosen survey; or behavioral responses based on decision-making processes.

According to some embodiments, the system further comprises a user interface, wherein: the simulated responses are responses or reactions to a text message and the target audience comprises recipients of the text message; and the computer processor is configured to receive, from a human user, over the user interface, an initial text message and iterate the following process: analyze the simulated responses, wherein the analysis comprises sentiment analysis or click-through rate; and generate, using a large language model, a new text message based on the simulated responses.

According to some embodiments, the computer memory retains the simulated responses and the computer processor is configured to use the retained simulated responses to improve subsequent simulated responses.

According to some embodiments, the computer processor is configured to aggregate the responses to simulate a collective response of a group of personas.

According to some embodiments, the computer processor is configured to prioritize the accuracy of the collective response compared to the accuracy of individual responses of individual personas.

According to some embodiments, the computer processor is configured to: embed one or more additional pre-existing surveys; form a multidimensional array of persona-question pairs based on the pre-existing personality survey and the one or more additional pre-existing surveys; and form, using the multidimensional array, a calibration manifold by cross-validating the pre-existing personality survey and the one or more additional pre-existing surveys.

According to some embodiments, the computer processor is configured to: adjust for biases across target audiences using the calibration manifold; validate a question with respect to the multidimensional array of persona-question pairs and/or validate a target audience with respect to the calibration manifold; and recommend additional data collection or adjustments in the event that the question and/or target audience falls outside of the calibration manifold.

According to some embodiments, the computer memory retains contextual data from at least one of the pre-existing surveys, the contextual data comprising at least one of: textual content of the questions and responses; type of questions; or format of responses; and the computer processor is configured to use the contextual data to calibrate the simulated responses.

### BRIEF DESCRIPTION OF THE DRAWINGS

The present invention will be more readily understood from the detailed description of embodiments thereof made in conjunction with the following accompanying drawings:

FIG. 1 shows a method of simulating responses from virtual personas according to some embodiments of the invention;

FIG. 2 shows a system for simulating survey responses according to some embodiments of the invention;

FIG. 3 shows a method of validating simulated survey responses according to some embodiments of the invention;

FIG. 4 shows a system for optimizing textual content according to some embodiments of the invention;

FIG. 5A shows a system for simulating behavioural experiments according to some embodiments of the invention;

FIG. 5B shows an example of a behavioural experiment which may be carried out by some embodiments of the invention; and

FIG. 6 shows a computing device which may be used with some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

The present invention utilizes artificial intelligence to perform advanced behavioral modeling, for example for survey design and content optimization. The system is designed to address the limitations of traditional methods by providing a more efficient, accurate, and scalable solution.

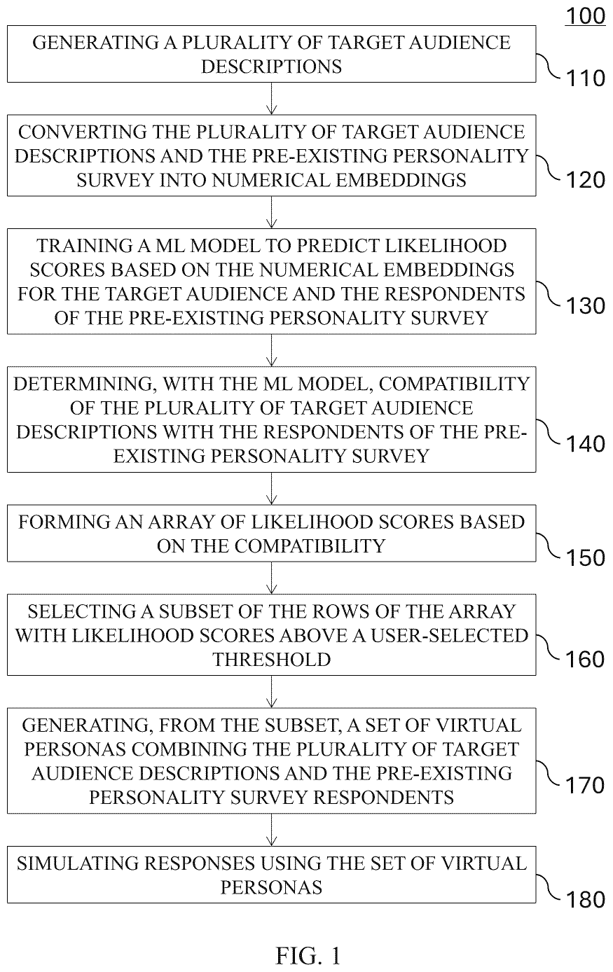

FIG. 1 shows method 100 of simulating responses from virtual personas. Step 110 may include generating a plurality of target audience descriptions. According to some embodiments, these descriptions may include attributes such as age range, location, education, job and other demographic attributes. Advantageously, this process may ensure diversity, with the focus of the attributes varying across, for example, domains and business problems in a given region (e.g., country, city, state, province, and/or the like).

The attributes to be included may be selected by a user or automatically selected, for example using a large language model (LLM), or a planner module as described further herein. The attributes may be selected based on business objectives, hypothetical scenarios and/or nature/purpose of the simulation.

For example, the target audience may be respondents to a survey, in which case the attributes included in the target audience descriptions may be selected based on the domain and/or questions of the survey. As further examples, the target audience may be recipients of a text message, or people carrying out behavioral actions and/or making decisions in response to an event.

The target audience descriptions may be generated using an LLM. According to some embodiments, 20,000 audience descriptions may be generated.

The next step 120 may include converting the plurality of target audience descriptions into numerical embeddings and converting a pre-existing personality survey into numerical embeddings. For example, this conversion may be performed using OpenAI embeddings or pre-trained Variational Autoencoder Transformers (VAT), which create continuous embedding manifolds.

Psychological and personality attributes may be beneficial for persona creation. For example, according to some embodiments, step 120 may advantageously include using Wave 6 of the World Value Survey for the pre-existing personality survey, due to its inclusion of BFI-10 personality assessments, where BFI-10 is a 10-item scale measuring the Big Five personality traits: Extraversion, Agreeableness, Conscientiousness, Emotional Stability, and Openness.

Step 130 may include training a machine learning model to predict likelihood scores based on the numerical embeddings for the target audience descriptions and based on the respondents of the pre-existing personality survey. The likelihood score may be measured between 0 and 1. According to some embodiments, the training and/or scoring process may be guided by prompt engineering and/or manual validation. Statistical techniques such as cross-validation and root mean square error (RMSE) evaluation may be used to ensure robustness. Step 130 may also include using deep learning to capture latent interactions between the embeddings.

Step 140 may include determining, with the machine learning model, compatibility of the plurality of target audience descriptions with respondents of the pre-existing personality survey. The compatibility may be quantified using the likelihood score, wherein the scoring may be guided by prompt engineering and manual validation.

The compatibility may, for example, be based on evaluating: the alignment of a survey respondent's job with the target audience's job category (e.g., a survey respondent's job not aligning with the target audience's job category may result in a low compatibility); the age difference between the survey respondents and the target audience (e.g., a target audience age of 60 may result in a lower compatibility for respondents aged 20 but higher for those aged 57); the alignment of a survey respondent's personality traits (e.g., BFI-10) with the audience description (e.g., a target audience of doctors may require specific combinations of Big Five traits).

Step 150 may include forming an array of likelihood scores based on the compatibility, wherein columns of the array correspond to the target audience descriptions and rows of the array correspond to the pre-existing personality survey. For example, the array may have a size of [20,000 target audiences] columns×[number of pre-existing survey respondents] rows.

Step 160 may include selecting a subset of the rows of the array with likelihood scores above a user-selected threshold, for example between 0 and 1. In particular, a high threshold, indicating strong alignment with the target audience, may be selected, for example 0.8.

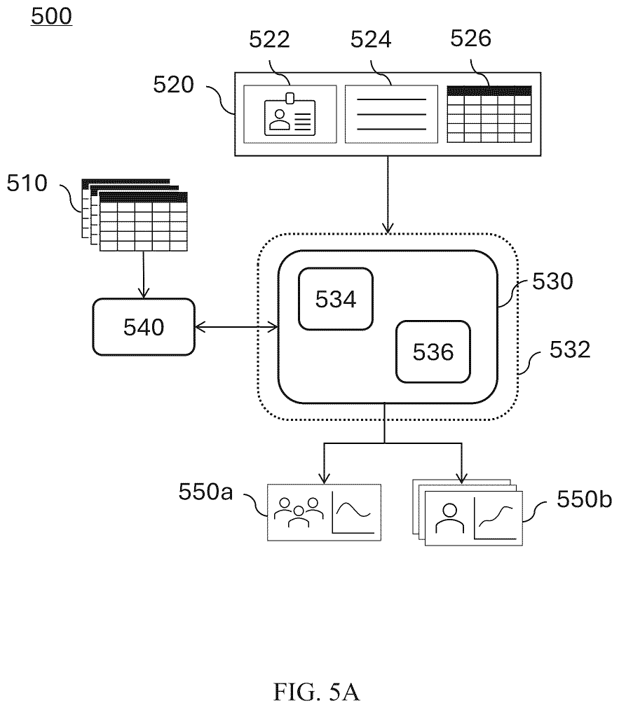

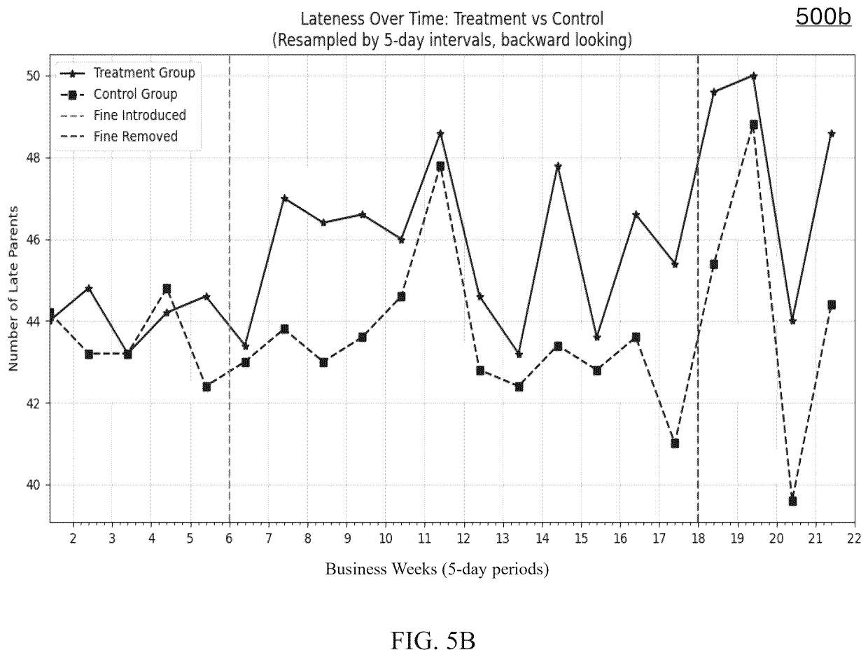

Step 170 may include generating, from the subset, a set of virtual personas combining the plurality of target audience descriptions and the pre-existing personality survey respondents. This may include combining demographic details, personality traits, and other features from the subset of rows. Further example features are described with reference to FIG. 5B. The combining of features may involve statistical techniques such as factor analysis, which may, advantageously, reduce redundancy. Different features may also be weighted differently in the combination; for example, Big Five personality traits may be weighted highly as they may be particularly beneficial for persona accuracy. Each virtual persona may be converted into a text description. According to some embodiments, the text description may include only the features which are relevant for the purpose of the persona.

Step 180 may include simulating responses using the set of virtual personas. This may include: simulating survey responses; simulating responses to a text message; or simulating behavioral responses in decision-making processes.

According to some embodiments, method 100 may be used to simulate responses to surveys. In particular, the simulated responses of step 180 may be responses to questions in a chosen survey and the target audience may comprise respondents to the chosen survey.

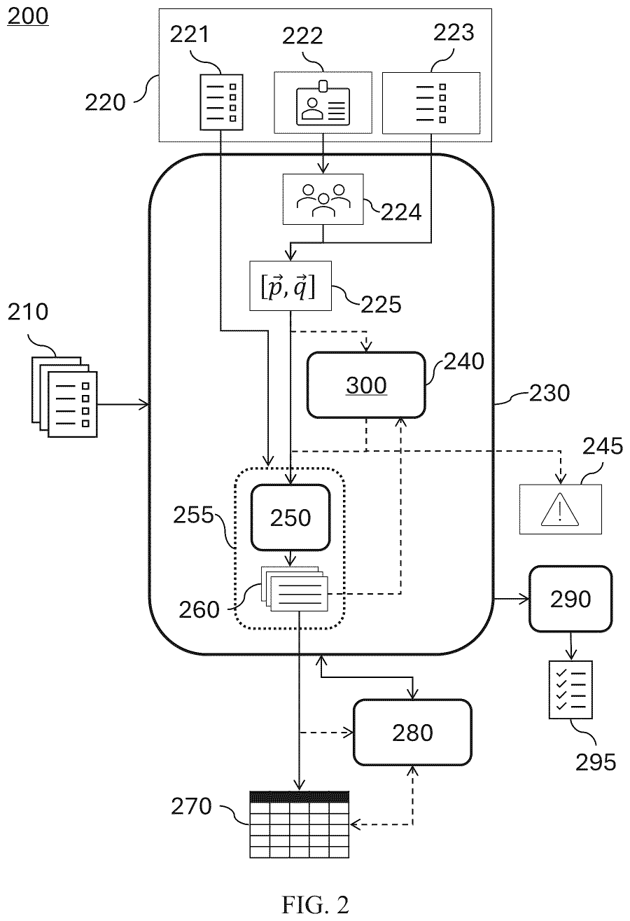

FIG. 2 shows a system for simulating responses to surveys using the virtual personas generated in method 100. The system may include a machine learning (ML) model 230. ML model 230 may include various sub-modules, e.g. LLM 250 and calibration module 240. Each module may correspond to a specific layer of the process, advantageously allowing for scalability, flexibility, and ease of integration.

For example, ML model 230 may include LLM 250 to analyze the textual content and simulate textual responses 260 to survey questions. LLM 250 may be based on the OLLAMA platform, or on APIs of third-party providers such as GPT, Claude, Llama, etc. LLM 250 may also have a context window 255 which stores information temporarily, for example throughout the duration of a simulation/user request but deleted thereafter.

A user may provide, via a user interface, ML model 230 with a user request 220 including a target audience 222 and a survey/survey questions 223. User request 220 may also include pre-existing survey data 221 that is relevant to user request 220, e.g. surveys with a similar demographic to target audience 222 and/or a similar domain to survey questions 223.

Target audience 222 may, for example, include descriptions/details of the target demographic and a desired number of responses. ML model 230 may numerically embed target audience 222 and survey questions 223. From the set of virtual personas generated in step 170 of method 100 (described with reference to FIG. 1), ML model 230 may select a subset of virtual personas 224 which align with target audience 222, e.g. wherein virtual personas 224 align with the target demographic and the size of the subset corresponds to the desired number of responses, as defined by target audience 222. ML model 230 may select subset 224 by comparing the numerical embeddings of the target demographic 222 and the set of virtual personas from step 170.

ML model 230 may then generate, for each virtual persona in the subset 224 and each survey question from survey 223, a persona-question pair 225, [\vec{p}, \vec{q}], where \vec{p} and \vec{q} may be data structures encoding information relating to each virtual persona and question, respectively. Persona-question pairs 225 may be provided to LLM 250, which may simulate, e.g. act as, virtual personas 224. In particular, LLM 250 may predict how each virtual persona would answer each question depending on that virtual persona's various demographic attributes.

According to some embodiments, additional survey data 221 may be added to context window 225 of LLM 250 to optimize LLM 250 for present user request 220, for example using cross-validation and/or out-of-sample testing. This may advantageously improve the accuracy of the responses for the specific domain and/or demographic of user request 220. Survey data 221 may be deleted after the present request is completed, e.g. after the simulated responses have been outputted, to avoid adding a bias (e.g. towards the domain/demographic of user request 220) to the ML model. Alternatively, survey data 221 may be retained, e.g. added to a training dataset in a computer memory 280, to further train ML model 230 offline.

According to some embodiments, persona-question pairs 225 may be provided directly to LLM 250. According to other embodiments, persona-question pairs 225 may be validated by a calibration module 240 before being provided to and received by LLM 250. For example, the calibration module may determine, using method 300, whether ML model 230 is equipped, e.g. adequately trained, to accurately generate a response for each persona-question pair 225. In particular, calibration module 240 may only send the persona-question pair to LLM 250 upon determining that it is valid. In the event that calibration module 240 is not able to find enough valid persona-question pairs to meet the user's desired number of responses, e.g. as defined in target audience 222, system 200 may output an alert 245 to the user, for example suggesting adjustments to request 220, further data collection, and/or offline training.

According to some embodiments, simulated responses 260 may be retained in the context window 255 of LLM 250, such that a virtual persona's response to one question may be stored and used to influence that same persona's response to a subsequent question. This may advantageously simulate real human memory, contextual reasoning, and biases, which may result in more realistic responses.

Simulated responses 260 may be recorded and aggregated, e.g. in memory 280, for further analysis. For example, ML model 230 may analyze simulated responses 260 at both individual and collective levels, in order to provide, respectively, micro-level insights and macro-level trends. According to some embodiments, the randomness of the LLM's outputs may be fine-tuned to achieve a desired balance between aggregate accuracy and individual persona realism. For example, simulated responses 260 may be aggregated to simulate a collective response of a group of personas, wherein, according to some embodiments, the accuracy of the collective response is prioritized compared to the accuracy of individual responses of individual personas.

Aggregate responses may include confidence intervals, which may be used by ML model 230, in particular by planner module 290 as described further herein, to provide error estimates and actionable insights to the user.

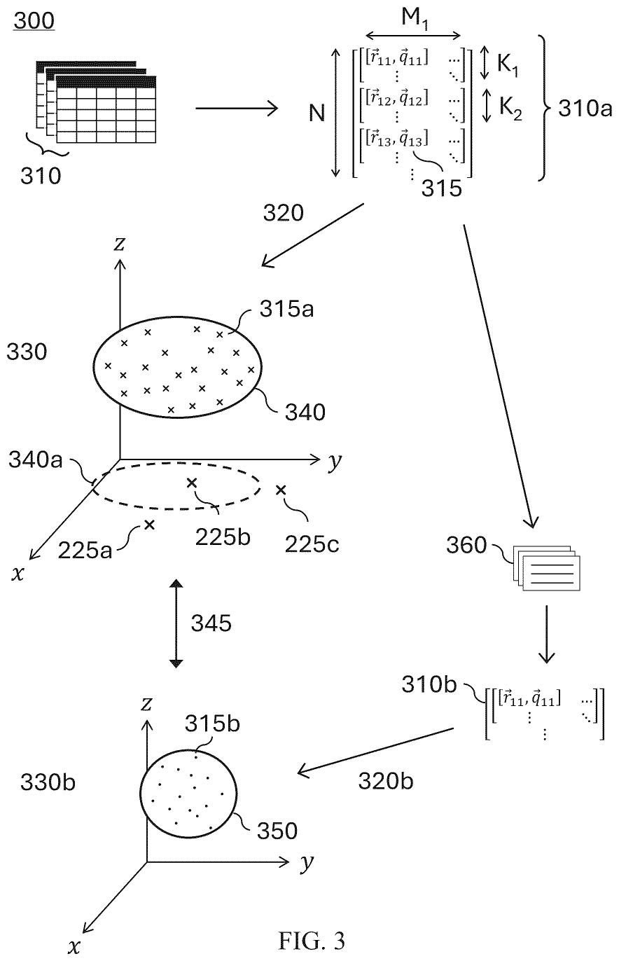

Simulated responses 260 may be converted into a user-friendly output, e.g. dataset 270. Dataset 270 may include the questions, responses and demographic details of the virtual respondents/personas. Dataset 270 may be stored in a computer memory 280 and used to improve subsequent simulations. For example, simulated responses 260 may be evaluated using statistical techniques and cross-validated with pre-existing data, e.g. as described further with reference to FIG. 3, in order to train LLM 250 further.

Simulated responses 260 may also be processed by calibration module 240 to further calibrate ML model 230. For example, ML model 230 may undergo calibration and bias correction whilst offline using calibration module 240. In particular, ML model 230 may be provided with additional pre-existing surveys 210. Pre-existing surveys 210 may advantageously include a variety of diverse and reliable pre-existing surveys, wherein diversity corresponds to surveys spanning various domains and demographics, and reliability corresponds to surveys with well-established collection methodologies.

FIG. 3 is now used to explain how pre-existing surveys 210 may be used to calibrate/train ML model 230. In particular, pre-existing surveys 210 may be used to form a dataset 310 including respondent demographics, survey questions, and real responses. Dataset 310 may further include contextual data, such as the textual content of the questions and responses, type of questions, and format of responses. Advantageously, this may allow calibration with respect to nuances in phrasing and meaning.

Dataset 310 may be numerically embedded as in step 120 (as described with reference to FIG. 1). The numerical embeddings may be organized into respondent-question pairs [\vec{r},\vec{q}], e.g. array element 315, analogous to persona-question pairs 225, [\vec{p},\vec{q}]. The respondent-question pairs may be arranged into a multidimensional array, or tensor, 310a.

For example, given N surveys, each survey n may have Mₙ respondents and Kₙ questions. This may be represented by a multidimensional array 310a with N layers, each with an array containing Mₙ×Kₙ respondent-question pairs [\vec{r}ₘₙ,\vec{q}ₖₙ], giving total dimensions N×Mₙ×Kₙ. The Mₙ×Kₙ arrays may each have different dimensions and may be jagged, e.g. not square/rectangular, depending on the number of respondents and questions in each survey n. For example, one survey n=3 may have M₃=100 respondents and K₃=25 questions.

Each respondent-question pair [\vec{r}ₘₙ,\vec{q}ₖₙ] may represent a specific respondent and question. For example, array element 315, [\vec{r}₁₃,\vec{q}₁₃], may represent respondent m=1 and question k=1 of survey n=3. According to some embodiments, the respondent-question pairs may be data structures that encode, contain and/or point to information and/or data associated with respective respondent and question, e.g. demographic details of the respondent, domain of the question, textual content of the question, etc. The associated data may be stored, e.g. encoded or contained, within the data structure respondent-question pair, such that the dimensions of multidimensional array 310a may remain N×Mₙ×Kₙ; or they may be stored in one or more additional dimensions or data channels, which may for example give overall dimensions N×Mₙ×Kₙ×Jₙ, wherein the respondent-question pair acts as a pointer to the associated data.

According to some embodiments, each respondent-question pair may, e.g. further or alternatively, represent the corresponding response, e.g., for array element 315, the response of respondent m=1 to question k=1 of survey n=3. As above, the associated response may be stored and/or encoded within the data structure of the respondent-question pair, giving dimensions N×Mₙ×Kₙ, or stored in an additional dimension/data channel of multidimensional array 310a, giving e.g. dimensions N×Mₙ×Kₙ×2.

According to some embodiments any or all of the herein-mentioned data, e.g. demographic details of the respondents, textual content of the questions and/or responses, etc., may be stored in a separate array, dataset and/or data structure, e.g. elsewhere in computer memory 280, wherein the respondent-question pairs may act as pointers thereto.

Dataset 310 may be used to train ML model 230. Step 320 may involve mapping, e.g. plotting, the respondent-question pairs from array 310a, along with their respective associated responses, onto a graph 330, where the axes x, y and z correspond to the numerical embeddings of the respondents, questions and responses, respectively. Plotting the respondent-question pairs forms a three-dimensional manifold, calibration manifold 340, encompassing the respondent-question pairs; for example, datapoint 315a, which may include respondent-question pair 315 and its associated response, lies within calibration manifold 340.

Calibration manifold 340 may represent the scope of knowledge of ML model 230, e.g. the kinds of respondents, questions and responses familiar to ML model 230, and may be used to calibrate responses 260 simulated by LLM 250. The manifold may provide a big-picture view across various demographics and survey domains and thus may be able capture latent interactions amongst them as well as other nuances.

Calibration manifold 340 may be continuously updated as further pre-existing data 210 is provided to the system and added to dataset 310. This may increase the volume of the manifold so that it covers more demographics and domains, thereby increasing the number of persona-question pairs 225 found valid by calibration module 240 and thus allowing ML model 230 to successfully parse more user requests 220. If calibration manifold 340 is not uniform or exhibits a skew, this may indicate a bias in dataset 310; in this case, the system, e.g. planning module 290, may advise the user, e.g. via an alert 245, that more training data is required.

During offline calibration, LLM 250 may use the respondent-question pairs [\vec{r},\vec{q}] from dataset 310, i.e. the real respondents and questions from the pre-existing surveys, to simulate responses 360. For example, LLM 250 may predict and generate a response based on respondent-question pair 315, which may then be compared and/or cross-validated with the real response associated therewith.

Simulated responses 360 may be stored, e.g. in computer memory 280, in a separate dataset to dataset 310, wherein the respondent-question pairs may encode pointers thereto. According to some embodiments, simulated responses 360 may be added to dataset 310/array 310a, e.g. organized according to their respective respondent-question pair. For example, simulated responses 360 may be associated with the respondent-question pairs by adding another dimension/data channel to multidimensional array 310a; for example, array 310a may be concatenated with simulated responses 360 to produce a simulation array 310b with dimensions N×Mₙ×Kₙ×2. Simulated responses 360 may alternatively be stored and/or encoded within the data structure of the respondent-question pairs, such that the overall dimensions of simulation array 310b may remain N×Mₙ×Kₙ. Not all of the respondent-question pairs may be used to simulate responses and thus simulation array 310b may be jagged.

LLM-simulated responses 360 may be plotted 320b as in step 320, thereby forming another manifold, simulation manifold 350. For example, the simulated response to respondent-question pair 315 may be mapped onto graph 330b as datapoint 315b. It may therefore be possible to compute a bijective mapping between datapoints 315a and 315b, representing the accuracy of the prediction. This may allow a direct comparison and evaluation of accuracy between the real responses and simulated responses 360, which may in turn reflect the accuracy of simulated responses 260 and thus the overall accuracy and/or performance of ML model 230, in particular LLM 250. This can be used to train ML model 230.

In a similar way, a calibration function 345, mapping calibration manifold 340 and simulation manifold 350 to each other, may be calculated, e.g. by calibration module 240. Calibration function 345 may be calculated based on the direct mappings between simulated responses 360 and the corresponding real responses. The calculation may be further based on/informed by the features of the respondents, e.g. demographic details; features of the questions, e.g. domain; and features of simulated responses 360 as compared to features of the corresponding real responses. For example, calibration module 240 may use the numerical embeddings of such features in the calculation of calibration function 345.

Calibration function 345 may allow ML model 230 to learn and evaluate the correspondence between real data, e.g. dataset 310, and LLM-simulated outputs, e.g. simulated responses 260 and 360. The calibration function may also allow ML model 230 to check for potential biases towards domains and demographics in the LLM-simulated responses, wherein LLM 250 may be prompted to regenerate a response accordingly. If a substantial bias is determined, the user may be alerted, e.g. via alert 245, that further data collection is recommended.

Simulation manifold 350 and calibration function 345 may be continuously updated as new data is added to calibration manifold 340 and as new responses 260/360 are simulated and added to simulation manifold 350. They may be further updated in view of the determined accuracy of the simulated responses. Over time, simulation manifold 350 may tend towards calibration manifold 340, e.g. in shape, and calibration function 345 may tend to 1.

During the online simulation, calibration module 240 may evaluate the validity of persona-question pairs 225 prior to simulating responses 260. For example, calibration module 240 may iterate through persona-question pairs 225 and map them onto graph 330, wherein area 340a is a projection of calibration manifold 340 onto the respondent-question, x-y, plane. In particular, persona-question pairs 225 fall within the x-y plane as the mapping is performed prior to simulating the response.

For example, consider a persona-question pair 225a of the set of persona-question pairs 225. When mapped onto graph 330, persona-question pair 225a may fall outside of area 340a, in particular within the y-dimension of calibration manifold 340 but outside of the x-dimension; this may indicate that persona-question pair 225a contains a valid question but an invalid persona. Similarly, persona-question pair 225c may contain a valid persona but invalid question, as indicated by its position with respect to area 340a. ML model 230 may not be well-equipped to simulate a response for these persona-question pairs and thus calibration module 240 may invalidate them and/or not pass them on to LLM 225. In contrast, persona-question pair 225b may fall within area 340a and thus calibration module 240 may validate it and/or pass it on to LLM 250 for response simulation.

Calibration module 240 may be configured to allow and/or validate persona-question pairs that fall outside of area 340a, e.g. within a tolerance/threshold. This tolerance may be defined and/or adjusted by the user. Planner module 290, as described further herein, may also advise the user as to adjustments to the tolerance.

Calibration module 240 may provide LLM 250 with additional calibration information alongside persona-question pair 225b, so that the simulation of the response associated therewith may be informed, for example, by simulation manifold 350 and/or calibration function 345. After simulating a response for persona-question pair 225b, LLM 250 may send the simulated response back to calibration module 240 to check that it falls within calibration manifold 340.

According to some embodiments, deep learning features may be incorporated into ML model 230. For example, ML model 230 may be able to capture latent interactions among the embedding features of the personas, questions and responses. Advantageously, these latent interactions may be reflected in calibration manifold 340 in order to achieve more robust calibration, accounting for more nuances and thus leading to higher calibration accuracy.

ML model 230 may also be trained using transfer learning. For example, LLM 250 may also simulate responses based on respondent/persona-question pairs of: real respondents and real questions, e.g. from datasets 210/310, but across different surveys (e.g., simulating how a respondent of survey 3 would answer a question from survey 1); virtual personas, e.g. as generated in method 100 and/or subset 224, and real questions; real respondents and new questions, e.g. inputted by the user; and/or virtual personas and new/inputted questions. Using transfer learning, ML model 230 may be able to determine the accuracy and/or validity of these persona-question pairs and responses using calibration manifold 340 and calibration function 345, and other cross-validation techniques. Simulation array 310b may also be utilized by ML model 230 for transfer learning.

According to some embodiments, system 200 may include a planner module 290 which may advantageously help the user transition from a general research idea to specific, testable questions suitable for surveys. For example, the user may provide questions, and planner module 290 may suggest a suitable target audience. As another example, the user may provide a target audience and/or a domain, and the planner module may suggest suitable questions.

Planner module 290 may provide a user-friendly structured checklist 295 outlining suggested changes, additional inputs necessary for running the survey, and other actionable steps to implement the survey. For example, planner module 290 may provide feedback to the user suggesting refinements to questions 223 in order to align them with target audience 222 and the user's research objectives, or suggesting adjustments to target audience 222 to align with the questions 223. As previously discussed, the planner module may also suggest additional data input if calibration module 240 determines that ML model 230 has not been adequately trained for the request, and may further suggest a validation tolerance of calibration module 240, e.g. based on the performance/accuracy of ML model 230.

Referring back to FIG. 1, according to some embodiments, method 100 may be used to simulate responses and/or reactions to text messages, wherein the target audience may comprise recipients of the text message.

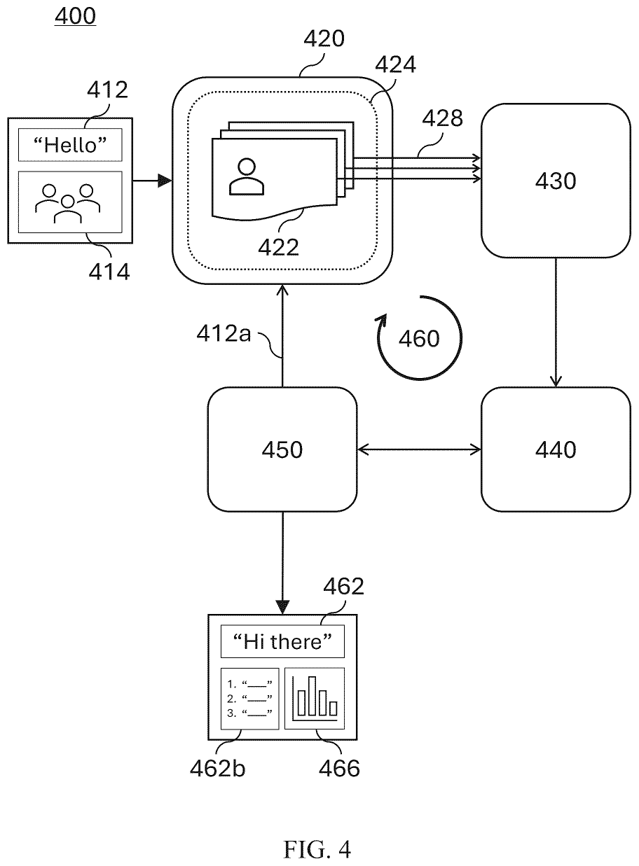

FIG. 4 shows a text assessment and optimization module 400 configured to generate optimized textual content. In particular, module 400 may carry out an iterative process wherein text messages may be tested against virtual personas, as generated in step 170, and edited and/or improved accordingly.

Module 400 may comprise a behavioral AI 420 with a decision environment 424. Behavioral AI may also contain the demographic description profiles 422 of the virtual personas generated in step 170. Behavioral AI 420 may receive an initial text 410 input by a user. Text 410 may be tested against virtual personas 422; in particular, behavioral AI 420 may simulate responses 428 for each virtual persona 422 using decision environment 424. The user may also input, along with initial text 410, a target audience 414 against which text 410 should be tested, in which case behavioral AI 420 may only test text 410 against virtual personas 428 which match target audience 414, wherein behavioral AI 420 may, for example, determine the matches using numerical embeddings. The user may also adjust variables and features of decision environment 424, e.g. via prompt engineering.

Simulated responses 428 may, for example, include textual content, emojis, time to respond, and/or no response at all, e.g. simulating whether the text message is clicked on or opened. The user may define further features/metrics to be simulated.

Simulated responses 428 may be sent to an aggregate assessment module 430 to be analyzed, thereby initiating iterative process 460. Aggregate assessment module 430 may use sentiment analysis to analyze textual content and emojis, and compute click-through rates and response times. Aggregate assessment module 430 may accordingly assign a performance score to initial text message 410 based on the analysis of the responses, in particular how positive the responses are. Aggregate assessment module 430 may compute an overall score for text 410 across all virtual personas 422 and demographics, or it may compute different scores for specific demographic features, e.g. as specified by the user in target audience description 414. For example, certain text messages may perform better with certain demographics.

Aggregate assessment module 430 may provide text 412 along with its performance score to computer memory 440. According to some embodiments, it may also provide details of its analysis, e.g. demographic details, the outcome of the sentiment analysis, etc. Computer memory 440 may in turn provide text 412 with its performance score, and optionally the analysis details, to text optimizer 450. Computer memory 440 may also store the text, score and/or analysis details, e.g. retain a copy thereof, prior to passing them onto text optimizer 450.

Text optimizer 450 may further analyze text message 412 with respect to its performance score, which may include predicting and/or determining how features of the text relate to the score, in particular which features are conducive to a positive response. Text optimizer 450 may utilize the analysis details sent by aggregate assessment module 400 to aid its analysis.

During iteration 460, computer memory 440 may, according to some embodiments, advantageously store and/or pass on only the highest-and lowest-scoring text messages received from aggregate assessment module 430, in order to reduce storage and computation requirements. Using these text messages with more extreme responses may advantageously improve the efficiency of the analysis performed by text optimizer 450.

Text optimizer 450, using a hypothesis-based ML algorithm, may edit and/or improve text 412 accordingly and send improved text 412a back to behavioral AI 420 to be tested against virtual personas 422 again, thereby restarting iterative process 460.

According to some embodiments, text optimizer 450 may send more than one improved text 412a, with different edits, to behavioral AI 420 simultaneously. According to some embodiments, text optimizer 450 may generate different improved texts 412a for different demographics, and behavioral AI 420 may test each improved text only against virtual personas 422 within the associated demographic. This may advantageously increase efficiency and reduce the number of iterations required.

According to some embodiments, the improved text messages 412a and analysis of text optimizer 450 may be retained, e.g. in memory 440, and used to train the ML model further; for example, text optimizer 450 may learn which features yield positive responses. This may advantageously aid future content refinement and analysis and therefore reduce the number of iterations needed in future user requests.

Iterative process 460 may be repeated until an optimal improved text message 462 is found, at which point the iteration 460 may be terminated and optimal text message 462 outputted to the user. According to some embodiments, an optimal text message 462 may be defined according to a performance score threshold, e.g. if its performance score as assigned by aggregate assessment module 430 exceeds this threshold. The score threshold may be preprogrammed, defined and/or adjusted by the user. Alternatively, according to other embodiments, iterative process 460 may be run for a defined period of time or number of iterations, which may be preprogrammed and/or user-defined.

According to some embodiments, the user may also pause iteration 460 at any time to view an improved text 412a, along with its simulated responses 428 and its performance score, and accordingly decide whether to terminate the iteration and output it as final text 462.

The system may provide optimal text 462 to the user along with alternative high-scoring texts 462b. For example, the system may provide different optimal texts 462b for different target audiences. The system may provide the user with a detailed analysis 466 of each high-scoring text 462b, e.g. including the performance of each text with different demographics.

Referring back to FIG. 1, according to some embodiments, method 100 may be used to simulate behavioral responses rather than textual responses. FIG. 5A shows a system 500 that may be used to model behavioral responses, based on decision-making processes, to an event.

The user may send a user request to system 500, in particular to a ML model 530, including a target audience 522 and an experiment 524. The experiment may, for example, be an event, a social setting, a physical environment, etc. ML model 530 may have a decision environment 532 simulating the setting and/or context of experiment 524. Experiment 524 may also include a particular meta prompt to fine-tune decision environment 532. The meta prompt may include details which ML model 530 can use to induce stages of thought related to behavioral effects and heuristics. This may inform and/or shape decision environment 532, which may in turn guide the decision-making process of ML model 530.

ML model 530 may be trained on datasets 510 of a diverse range of behavioral experiments. The user may also input relevant behavioral experiments 526 along with target audience 522 and experiment 524. Decision environment 532 may also include a context window such that ML model 530 has a memory of past actions, wherein additional relevant behavioral experiments 526 may be temporarily stored in context window 532 and deleted after the user request is completed in order to avoid adding bias to ML model 530; alternatively, they may be stored in memory 540 for future training.

ML model 530 may contain various modules such as an LLM 534 and a computational module 536. The modules may introduce feedback, limitations, uncertainty and randomness, e.g. via mathematical probability functions calculated by computational module 536, to decision environment 532 and the decision-making computations of ML model 530. This may advantageously improve the realism of the simulation.

ML model 530 may simulate experiment 520b against virtual personas, as generated in step 170 of method 100, matching the target audience 520a, wherein matching personas may be found by comparing numerical embeddings. ML model 530 may simulate experiment 524 on a plurality of virtual personas, e.g. a desired number of respondents as defined by the user. The system may alert the user if there are not enough matching virtual personas to meet the desired number of respondents, in which case the alert may recommend further data collection and/or training.

ML model 530 may compute aggregated metrics 550a for the entire group of virtual personas, modeling how a population may respond to experiment 524, as well as detailed analyses 550b for each virtual persona, modeling how different individuals may each respond to the experiment. ML model 530 may cross-validate its predictions against datasets 510, and, if provided, other relevant experiments 526. ML model 530 may optimize and/or fine-tune the simulation to find an optimal compromise between collective response 550a and individual responses 550b. Alternatively, according to some embodiments, collective response 550a may be prioritized, with respect to accuracy, compared to the individual responses 550b, or vice versa, e.g. as specified by the user.

System 500 may also include a planner module similar to planner module 290, which may help the user transition from a general hypothesis to an actionable experiment. The planner module may suggest a target audience, further data collection, and adjustments the experiment, and may provide other actionable suggestions to assist the user in carrying out the research.

FIG. 5B shows a simulation 500b that may be achieved by system 500. Simulation 500b models the impact, in particular lateness over time, in response to introducing late-fees for kindergarten pickups. The simulation includes physical and social environment interaction.

For example, the following target audience features may be included, e.g. in step 170 of method 100, in a set of virtual personas used for simulation 500b: Age, Gender, Employment Status, Number of Children, Socioeconomic Status, Health Status, Psychological Factors, Marital Status, Education Level, Big Five Personality Traits, Parenting Style, Name, Work, Time from Work to Kindergarten, Religious Observance, Distance from Home to Kindergarten, Family Support, Work Flexibility, Primary Transportation Method, Person ID, Kindergarten ID.

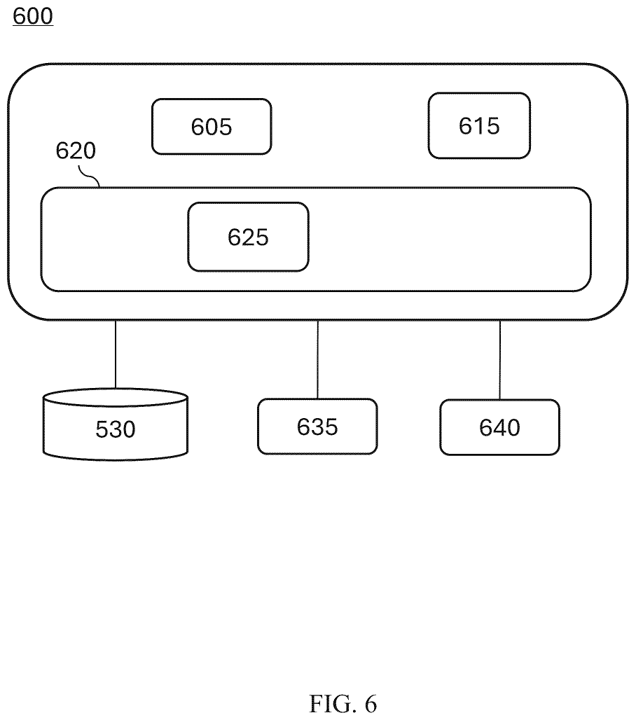

Reference is now made to FIG. 6, which is a block diagram of an exemplary computing device 600 which may be used with embodiments of the present invention. Computing device 600 may perform steps such as associating between mathematical terms of the PDE and physical characteristics of the laser beam.

Computing device 600 may include a controller or processor 605 that may be, for example, a central processing unit processor (CPU), a chip or any suitable computing or computational device, an operating system 615, a memory 620, a storage 630, input devices 635 and output devices 640.

Operating system 615 may be or may include any code segment designed and/or configured to perform tasks involving coordination, scheduling, arbitration, supervising, controlling or otherwise managing operation of computing device 600, for example, scheduling execution of programs. Memory 620 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 620 may be or may include a plurality of, possibly different, memory units. Memory 620 may store for example, instructions to carry out a method (e.g., code 625), e.g. method 100.

Executable code 625 may be any executable code, e.g., an application, a program, a process, task or script. Executable code 625 may be executed by controller 605 possibly under control of operating system 615. In some embodiments, more than one computing device 600 or components of device 600 may be used for multiple functions described herein. For the various modules and functions described herein, one or more computing devices 600 or components of computing device 600 may be used. Devices that include components similar or different to those included in computing device 600 may be used, and may be connected to a network and used as a system. One or more processor(s) 605 may be configured to carry out embodiments of the present invention by for example executing software or code. Storage 630 may be or may include, for example, a hard disk drive, a floppy disk drive, a Compact Disk (CD) drive, a CD-Recordable (CD-R) drive, a universal serial bus (USB) device or other suitable removable and/or fixed storage unit. Storage 630 may include cloud-based storage. Storage 630 may include database storage. In some embodiments, some of the components shown in FIG. 6 may be omitted.

Input devices 635 may be or may include a mouse, a keyboard, a touch screen or pad or any suitable input device. It will be recognized that any suitable number of input devices may be operatively connected to computing device 600 as shown by block 635. Output devices 640 may include one or more displays, speakers and/or any other suitable output devices. It will be recognized that any suitable number of output devices may be operatively connected to computing device 600 as shown by block 640. Any applicable input/output (I/O) devices may be connected to computing device 600, for example, a wired or wireless network interface card (NIC), a modem, printer or facsimile machine, a universal serial bus (USB) device or external hard drive may be included in input devices 635 and/or output devices 640.

Embodiments of the invention may include one or more article(s) (e.g., memory 620 or storage 630) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

As will be appreciated by one skilled in the art, aspects of the present invention may be embodied as a system, method and/or computer program product. A computer program product may contain code which causes an optical computing system, such as an optical computing system connected to a (“traditional” or non-optical) computing device/processor to perform method steps as described herein. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fibre, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fibre cable, RF, etc., or any suitable combination of the foregoing.

Computer program code for carrying out operations for aspects of the present invention may be written in any combination of one or more programming languages, including an object-oriented programming language such as Java, Smalltalk, JavaScript Object Notation (JSON), C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment”, “an embodiment”, or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting of” and grammatical variants thereof do not preclude the addition of one or more components, features, steps, or integers or groups thereof and that the terms are to be construed as specifying components, features, steps, or integers.

If the specification or claims refer to “an additional” element, that does not preclude there being more than one of the additional elements.

It is to be understood that where the claims or specification refer to “a” or “an” element, such reference is not construed that there is only one of that elements.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of simulating responses from virtual personas, the method comprising, using at least one computer processor:
generating a plurality of target demographic descriptions for a target demographic;
obtaining, from a pre-existing demographic dataset, a plurality of participant descriptions;
converting the plurality of target demographic descriptions and the plurality of participant descriptions into numerical embeddings;
training a machine learning model to determine a compatibility of a participant description with a target demographic description using the numerical embeddings thereof;
determining the compatibilities of the plurality of participant descriptions with the plurality of target demographic descriptions;
forming an array of likelihood scores based on the compatibilities, wherein columns of the array correspond to the target demographic descriptions and rows of the array correspond to the participant descriptions;
selecting a subset of the rows of the array with likelihood scores above a threshold;
generating, from the subset, one or more virtual personas, wherein a virtual persona comprises a combination of features from one or more target demographic descriptions and participant descriptions;
receiving a user input comprising a query and a target demographic; and
simulating one or more responses to the user input using the one or more virtual personas.

2. The method of claim 1, wherein the target demographic descriptions and the participant descriptions comprise at least one of: age range, location, education level, job, and personality.

3. The method of claim 1, wherein: the query comprises a survey; the target demographic comprises respondents to the survey; and the simulated responses comprise responses to questions in the survey.

4. The method of claim 1, wherein: the query comprises a social experiment; the target demographic comprises participants of the social experiment; and the simulated responses comprise behavioral responses based on decision-making processes.

5. The method of claim 1, wherein:
the query comprises a text message; the target demographic comprises one or more recipients of the text message; and the simulated responses comprise at least one of responses or reactions to the text message; and
the method further comprises iterating the following process:
analyzing the simulated responses, wherein the analysis comprises at least one of sentiment analysis or click-through rate; and
generating, using a large language model, a new text message based on the simulated responses.

6. The method of claim 1, further comprising at least one of:
simulating, using a virtual persona, a response of an individual target demographic member; and
simulating, using an aggregation of virtual personas, a collective response of a group of target demographic members.

7. The method of claim 6, wherein an accuracy of the collective response is prioritized compared to an accuracy of the individual response.

8. The method of claim 1, further comprising:
forming a training set based on one or more pre-existing datasets comprising queries, participants and responses;
converting the one or more pre-existing datasets into numerical embeddings;
forming a multidimensional array of participant-query pairs based on the numerical embeddings of the one or more pre-existing data sets; and
forming a calibration manifold by plotting the participant-query pairs.

9. The method of claim 8, further comprising adjusting for biases in the training set using at least one of: the calibration manifold, and cross-validation.

10. The method of claim 8, further comprising:
forming a set of persona-prompt pairs based on the set of virtual personas and the prompt;
validating a user input by plotting the persona-prompt pairs on the calibration manifold, wherein the validation is successful if a majority of the set of persona-prompt pairs falls inside of the calibration manifold; and
recommending, upon unsuccessful validation, at least one of: further pre-existing dataset collection, or adjustments to the user input.

11. The method of claim 8, further comprising calibrating a simulated response by converting the simulated response into a numerical embedding and plotting it on the calibration manifold.

12. A system for simulating responses from virtual personas, the system comprising:
a computer memory; and
one or more computer processor,
wherein the computer memory holds instructions which, when executed by the one or more computer processor, cause the one or more computer processor to:
generate a plurality of target audience descriptions;
convert the plurality of target audience descriptions into numerical embeddings;
convert a pre-existing personality survey into numerical embeddings;
determine, with a machine learning model, compatibility of the plurality of target audience descriptions with respondents of the pre-existing personality survey;
form an array of likelihood scores based on the compatibility, wherein columns of the array correspond to the target audience descriptions and rows correspond to the pre-existing personality survey;
select a subset of the rows of the array with likelihood scores above a threshold; generate, from the subset, a set of virtual personas combining the plurality of target audience descriptions and the pre-existing personality survey respondents; and
simulate responses using the set of virtual personas.

13. The system of claim 12, wherein the target audience descriptions comprise at least one of the following attributes: age range, location, education level, job, and demographic.

14. The system of claim 12, wherein the simulated responses are at least one of:
responses to questions in a chosen survey and the target audience comprises respondents to the chosen survey; or
behavioral responses based on decision-making processes.

15. The system of claim 12, further comprising a user interface, wherein:
the simulated responses are responses or reactions to a text message and the target audience comprises recipients of the text message;
the computer processor is configured to receive, from a human user, over the user interface, an initial text message and iterate the following process:
analyze the simulated responses, wherein the analysis comprises sentiment analysis or click-through rate; and
generate, using a large language model, a new text message based on the simulated responses.

16. The system of claim 12, wherein the computer memory retains the simulated responses and the computer processor is configured to use the retained simulated responses to improve subsequent simulated responses.

17. The system of claim 12, wherein the computer processor is configured to aggregate the responses to simulate a collective response of a group of personas.

18. The system of claim 17, wherein the computer processor is configured to prioritize the accuracy of the collective response compared to the accuracy of individual responses of individual personas.

19. The system of claim 12, wherein the computer processor is configured to:
embed one or more additional pre-existing surveys;
form a multidimensional array of persona-question pairs based on the pre-existing personality survey and the one or more additional pre-existing surveys; and
form, using the multidimensional array, a calibration manifold by cross-validating the pre-existing personality survey and the one or more additional pre-existing surveys.

20. The system of claim 18, wherein the computer processor is configured to:
adjust for biases across target audiences using the calibration manifold;
validate a question and a target audience with respect to the calibration manifold; and
recommend additional data collection or adjustments in the event that the question and/or target audience falls outside of the calibration manifold.

21. The system of claim 12, wherein:
the computer memory retains contextual data from at least one of the pre-existing surveys, the contextual data comprising at least one of: textual content of the questions and responses; type of questions; or format of responses; and
the computer processor is configured to use the contextual data to calibrate the simulated responses.
